(19) United States
(12) Patent Application Publication
(10) Pub. No.: US 2010/0006675 A1
(43) Pub. Date: Jan. 14, 2010

(54) FUEL INJECTOR WITH DIRECT CONTROL OF THE INJECTION VALVE MEMBER

(76) Inventor: Friedrich Boecking, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/722,220

(22) PCT Filed: Dec. 7, 2005
(86) PCT No.: PCT/EP05/56563

§ 371 Date: Jun. 20, 2007

(30) Foreign Application Priority Data
Dec. 23, 2004 (DE) 10 2004 062 007.5
Apr. 7, 2005 (DE) 10 2004 015 997.4

(51) Int. Cl. F02M 63/00

(52) U.S. Cl. 239/533.2

(57) ABSTRACT

A fuel injector with direct triggering of an injection valve member in which an actuator is received in the hollow chamber which is subjected to fuel that is at high pressure via a high-pressure source disposed outside the fuel injector. The actuator is supplied with current in the closing position of the injection valve member and is not supplied with current in the open position of the injection valve member. The actuator acts directly on a booster piston of a pressure booster, which booster piston acts upon the booster chamber. A control chamber sleeve defining a control chamber is movably received in the booster piston.

The invention relates to a fuel injector with direct control of the injection valve member as generically defined by the preamble to claim 1.

### PRIOR ART

German Patent Disclosure DE 10 2004 028 522.5 relates to a fuel injector with variable actuator stroke boosting. The fuel injector includes an actuator that directly actuates an injection valve member and acts on the injection valve member, which is urged in the closing direction via a spring element. The fuel injector includes a hydraulic coupler chamber that hydraulically connects a booster piston and the injection valve member with one another. A sleevelike body is braced on the injection valve member and cooperates with an edge that forms an intermediate stroke position of the injection valve member. The sleevelike body is movable relative to the injection valve member. With this embodiment, two-stage boosting can be achieved, with a first boosting stage being embodied by a stop.

From German Patent Disclosure DE 103 33 427 B3, a fuel system is known. The fuel system includes an injection valve, which has a valve needle for opening and closing injection openings. A line that carries fuel at high pressure to the injection valve in operation is provided, as are an actuator and a hydraulic coupler, the latter having two pistons, located linearly one behind the other and cooperating via a coupling of a coupler. The coupler volume of the coupler is formed by fuel at high pressure, via guide gaps of pistons disposed one behind the other. On each of the ends of the pistons remote from the actuator, a respective filling chamber is disposed and communicates with a line, and one of the pistons, with a first cross-sectional face, is connected to the actuator via a rod having an injection valve member embodied as a nozzle needle. The other two ends of the pistons engage associated booster chambers, which communicate hydraulically with one another via a conduit.

### ADVANTAGES OF THE INVENTION

According to the invention, a fuel injector for high-pressure reservoir injection systems (common rails) is proposed which has direct needle control, in which for opening an injection valve member that can be embodied as a nozzle needle, no hydraulic valve with which the pressure in a control chamber is relieved for opening the injection valve member is interposed between an actuator, such as a piezoelectric actuator, and the injection valve member. The actuator, which is preferably a piezoelectric actuator that has a piezoelectric crystal stack, is triggered inversely; the actuator is supplied with current in the closed state of the injection valve member embodied as a nozzle needle. For opening the injection valve member that can be embodied as a nozzle needle, the actuator is switched to a currentless state, so that the length of the piezoelectric crystal stack of the actuator decreases. As a result, a pressure reduction is brought about, which in turn causes an opening of the injection valve member that can be embodied as a nozzle needle.

In the fuel injector proposed according to the invention, a booster piston associated with the actuator has a control chamber sleeve surrounding it, and as a result one control chamber to be embodied otherwise in the body of the fuel injector can be dispensed with. The booster piston is advantageously embodied such that it acts upon both an inner booster chamber and an outer control chamber, the words inner and outer being with reference to the injection valve member. From the outer control chamber, fuel flows into a differential pressure chamber, which acts upon the injection valve member that can be embodied as a nozzle needle.

In the closing position of the injection valve member that can be embodied as a nozzle needle, the actuator is supplied with current. If the supply of current to the actuator is eliminated, the length of the piezoelectric crystal stack decreases, causing the booster piston to be retracted via a spring element associated with it and causing the pressure in the inner booster chamber to drop. The pressure reduction in the booster chamber causes a piston surrounding the injection valve member to move into the booster chamber. Because the current supply to the actuator is withdrawn, the pressure in a control chamber as well as in a differential pressure chamber, embodied inside the piston, of the injection valve member that can be embodied as a nozzle needle is reduced. To that end, the differential pressure chamber and the control chamber are both fluidically in communication with one another via a conduit containing a throttle restriction. If the piston moves upward because of the resultant pressure reduction in the booster chamber, the control chamber, and the differential pressure chamber of the injection valve member, then the injection valve member that can be embodied as a nozzle needle is likewise pulled open, it is carried along in the upward motion of the piston via a stop that can be embodied as a sleeve. Upon a further pressure reduction in the differential pressure chamber of the injection valve member that can be embodied as a nozzle needle, the injection valve member lifts from the stop embodied as a sleeve and opens farther.

For closing the injection valve member that can be embodied as a nozzle needle, current is again supplied to the actuator, so that the booster piston, which acts upon both the booster chamber and the control chamber, moves back in the direction of these chambers and causes a pressure increase in them. Via the conduit that contains a throttle restriction between the control chamber and the differential pressure chamber of the injection valve member that can be embodied as a nozzle needle, the injection valve member is returned to its closing position and accordingly seals off the injection openings that discharge into the combustion chamber of the internal combustion engine.

Accordingly, in a fuel injector having an actuator that is triggered inversely, an opening of the injection valve member that can be embodied as a nozzle needle is achieved by means of compulsory slaving of the injection valve member upon pressure relief of the booster chamber, and a further opening motion of the injection valve member is brought about because the differential pressure chamber of the injection valve member is further pressure-relieved upon pressure relief of the control chamber. Upon closure of the injection valve member that can be embodied as a nozzle needle, when current is supplied to the actuator, the retraction of the booster piston into both the booster chamber and the control chamber is effected, and as a result on the one hand the piston surrounding the injection valve member is subjected to pressure, and on the other, the differential pressure chamber of the injection valve member is subjected to pressure.

According to the invention, a fuel injector is furnished which enables a direct control of the injection valve member that can be embodied as a nozzle needle along with an extremely compact installation space. The proposed fuel injector is distinguished by a small number of components and by a low structural height, which is due to the fact that a hydraulic valve for actuating the injection valve member that can be embodied as a nozzle needle can be omitted.

### DRAWING

The invention will be described in further detail in conjunction with the drawing.

Shown are:

FIG. 1, a section through the fuel injector proposed according to the invention, with direct control of the injection valve member and inverse triggering of an actuator; and

FIG. 2, a further variant embodiment of the fuel injector proposed according to the invention.

### EXEMPLARY EMBODIMENTS

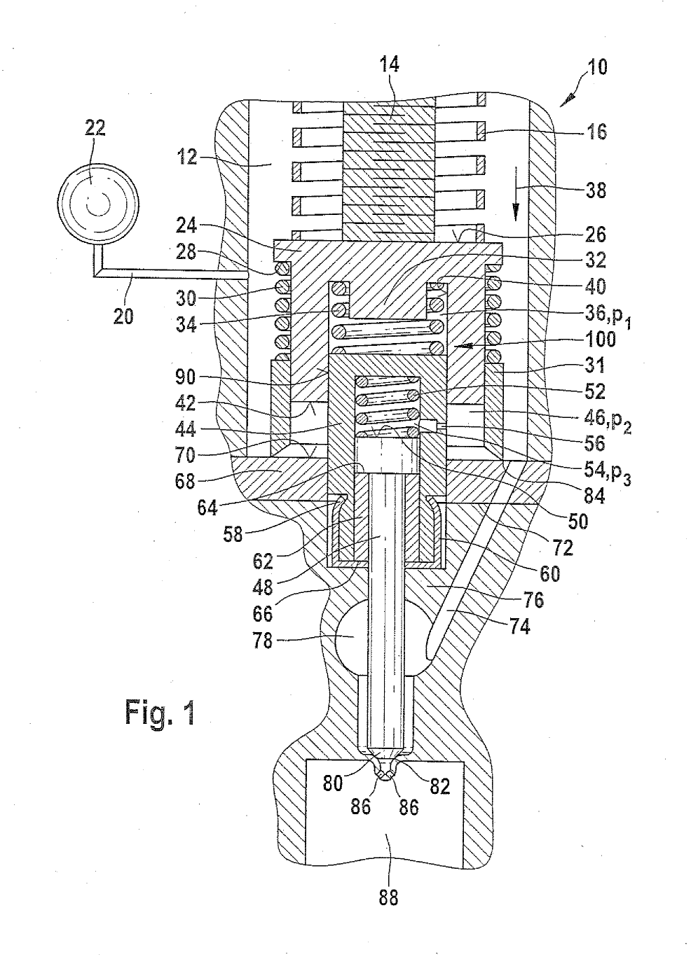

From the view in FIG. 1, a fuel injector 10 can be seen, which has a hollow chamber 12 in which an actuator 14, preferably embodied as a piezoelectric actuator, is received. A supply line 20 of a high-pressure source 22, such as a high-pressure collection chamber (common rail), disposed outside the fuel injector 10 discharges into the hollow chamber 12.

The actuator 14, preferably a piezoelectric actuator, includes a number of piezoelectric crystals stacked in layers one above the other and is triggered inversely. This means that the actuator 14 is supplied with current in the closed state of an injection valve member embodied as a nozzle needle, or in other words when injection openings 86 are closed, while conversely for opening the injection valve member 48, the actuator is switched to a currentless state, which is effected via a triggering, not shown in the drawing.

A spring element 16 embodied as a tubular spring is positioned against a face end 26, toward the actuator 14, of a booster piston 24. The booster piston 24 has an annular face 28, which fits over a further spring element 30 that in turn fits over a control chamber sleeve 31. Via the further spring element 30 placed against the control chamber sleeve 31 by the booster piston 24, the control chamber sleeve 31 is positioned with a bite edge 84 against a first plane face 70 of an intermediate disk 68 of the fuel injector 10.

The control piston 24 has an extension 32, which serves on the one hand as a guide for an inner spring element 34 and on the other defines a booster chamber 36, formed by an inner circumferential surface 40 of the booster piston 24 and a piston 44. A pressure level which is designated p₁ prevails in the booster chamber 36.

The booster chamber 12 of the fuel injector 10 subjected to fuel at high pressure via the supply line 20 has an inlet 38, 74, by way of which the fuel flows from the hollow chamber 12 to a nozzle chamber 78. The nozzle chamber 78 surrounds the injection valve member that can be embodied as a nozzle needle.

The booster piston 24 furthermore has an annular face 42, which defines a control chamber 46. The control chamber 46 is defined by the aforementioned annular face 42 of the booster piston 24 and by the inner circumferential surface of the control chamber sleeve 31 as well as the intermediate disk 68 of the fuel injector 10. The control chamber 46 surrounding the piston 44 is in communication with a differential pressure chamber 54, via a conduit in which a throttle restriction 56 is embodied. A closing spring 52 acting on the injection valve member that can be embodied as a nozzle needle is received inside the differential pressure chamber 54. The closing spring 52 is braced on one end on a face end 50 of the injection valve member 48 and on the other on the inside of the piston 44. Via the conduit having the throttle restriction 56, the differential pressure chamber 54, in which a pressure level p₃ prevails, and the control chamber 46, in which a pressure level p₂ prevails are in hydraulic communication with one another.

The injection valve member that can be embodied as a nozzle needle is movably received in the piston 44. To that end, on the side toward the nozzle chamber 78, there is a bell 60 on the piston 44, which can be connected to the piston 44 by nonpositive or positive engagement at a calked feature 58. In the lower region of the piston 44, the bell 60 surrounds a stop 62 that can be embodied as a sleeve. The injection valve member that can be embodied as a nozzle needle is guided movably in the axial direction in the stop 62. The stop 62 that can be embodied as a sleeve includes both a first side 64 and a second side 66, the latter pointing toward the bell 60. The piston 44 and the bell 60 received on it are guided movably in the vertical direction in the nozzle body 76 of the fuel injector 10.

From the nozzle chamber 78, fuel flows toward a tip 80 of the injection valve member that can be embodied as a nozzle needle, which injection valve member is placed, in its closed position, in a seat 82 on the combustion chamber end. As a result, injection openings 86 discharging into a combustion chamber 88 of an internal combustion engine are closed.

Reference numeral 90 designates a guide face between the booster piston 24 and the piston 44 surrounding the injection valve member 48.

The actuator 14, which acts upon the face end 26 of the booster piston 24, is triggered inversely. This means that in the closed state of the injection valve member 48, the actuator 14 is supplied with current, while conversely for opening the injection valve member that can be embodied as a nozzle needle, the actuator is not supplied with current.

When the actuator 14 is supplied with current and accordingly the injection valve member 48 is closed, the injection valve member is placed in its seat 82 that closes the injection openings 86. The piezoelectric crystals of the actuator 14, located one above the other in stack form, are lengthened counter to the action of the spring element 16, which can embodied as a tubular spring. The face end 26 of the booster piston 24 is acted upon by the piezoelectric actuator 14. The booster piston 24 thus maintains a pressure in the booster chamber 36 and is retracted with its annular face 42 into the control chamber 46, so that in the latter chamber an increased pressure likewise prevails. The increased pressure prevailing in the control chamber 46 is applied via the conduit that hydraulically connects the differential pressure chamber 54 to the control chamber 46. Because of the pressure prevailing in the booster chamber 36 and the pressure prevailing in the differential pressure chamber 54, both the piston 44 and the face end 50 of the injection valve member that can be embodied as a nozzle needle are subjected to pressure. The fuel volume present in the nozzle chamber 78 via the high-pressure inlet 38, 74 cannot be injected into the combustion chamber 88 of the engine, because the injection openings 86 are closed by the injection valve member 48. In the closing position of the injection valve member that can be embodied as a nozzle needle, this injection valve member rests on the first side 64 of the stop 62 that can be embodied as a sleeve. The stop 62 that can be embodied as a sleeve is furthermore fixed on its second side 66 by the bell 60. The piston 44 together with the bell 60 received on it is placed in the nozzle body 76 because of the pressure prevailing in the booster chamber 36 and is located in its lower stop position.

Upon opening of the injection valve member that can be embodied as a nozzle needle, the current supply to the actuator 14 is withdrawn, so that the length of the piezoelectric crystal stack of the actuator 14 decreases. Because of the action of the spring element 16 that can be embodied as a tubular spring, the booster piston 24 is pulled into the hollow chamber 12. This is associated both with a pressure relief of the booster chamber 36, by outward motion of the extension 32 from it, and a pressure relief of the control chamber 46, by movement of the annular face 42 of the booster piston 24 out of the control chamber. Because of the pressure relief in the control chamber 46, a pressure relief, although delayed, of the differential pressure chamber 54 also takes place on the back side of the injection valve member that can be embodied as a nozzle needle. Upon an outward motion of the booster piston 24, a simultaneous pressure relief thus takes place of both the booster chamber 36 and the control chamber 46. The piston 44 that with its face end defines the booster chamber 36 moves into the booster chamber 36. The bell 60, disposed on the piston 44 and surrounding the stop 62, causes the nozzle needle 48 to be engaged from below upon an upward motion of the piston 44 into the booster chamber 36 and consequently to follow the vertical upward motion of the piston 44. Since at the same time, because of the pressure relief in the control chamber 46 by the annular face 42, moving outward from it, of the booster piston 24 a pressure reduction is also effected in the differential pressure chamber 54, the face end 50 of the injection valve member that can be embodied as a nozzle needle moves into the differential pressure chamber 54, counter to the action of the closing spring 52, and lifts away from the first side 64 of the stop 62. A further opening motion of the injection valve member 48 into the differential pressure chamber 54 thus takes place, which motion is limited by the spring force of the closing spring 52. The fuel present in the nozzle chamber 78 can now be injected into the combustion chamber 88 of the engine, via the opened injection openings 86 on the combustion chamber end of the fuel injector 10.

On the one hand, upon pressure relief of the booster chamber 36, the stop 62 that can be embodied as a sleeve enables a slaving motion of the injection valve member that can be embodied as a nozzle needle upon an upward motion of the piston 44 into the booster chamber 36; on the other hand, a lifting of the injection valve member that can be embodied as a nozzle needle from the first side 64 of the stop 62 upon pressure relief of the differential pressure chamber 54 and pressure relief of the control chamber 46 is made possible. The opening motion of the injection valve member 48 when the actuator 14 has been switched to be currentless is accordingly effected by means of a superposition of the upward motion of the piston 44 into the booster chamber 36 upon its pressure relief and upon a parallel pressure relief of the differential pressure chamber 54 into the likewise pressure-relieved control chamber 46, causing the face end 50 of the injection valve member 48 to move farther into the differential pressure chamber 54. Upon closure, or in other words upon a supply of current to the piezoelectric actuator 14, a pressure increase conversely occurs in the booster chamber 36, causing the piston 44 to be pressed downward in the direction of the combustion chamber end of the fuel injector 10 in the nozzle body and causing a pressure increase in the differential pressure chamber 54, which communicates hydraulically with the control chamber 46 via the conduit having the throttle restriction 56, in which control chamber, because of the inward motion of the booster piston 24 with its annular face 42, the pressure likewise rises. Advantageously, the control chamber sleeve 31 is embodied such that the control chamber sleeve on the one hand defines the booster chamber 36 and on the other, together with the annular face 42 of the booster piston 24 and a surface region of a first plane face 70 of the intermediate disk 68, forms the control chamber 46. A second plane face of the intermediate disk 68 is identified by reference numeral 72.

Because the booster piston 24 and the piston 44, guided in it and subjected to the inner spring element 34, are nested one inside the other, an especially compact construction of a fuel injector 10 that makes direct triggering of the injection valve member 48 possible can be furnished, in which the control chamber 46 is advantageously formed by the use of a control chamber sleeve 31 that is movable relative to the booster piston 24. This makes it possible to dispense with the production of the control chamber 46 in the injector body. By means of the control chamber sleeve 31, the control chamber 46 can be embodied in the hollow chamber 12 of the fuel injector 10. Filling of the booster chamber 36 and the control chamber 36 is effected via the gaps, established as conditions of production, at the guide face 90 between the booster piston 24 and the piston 44, and between the first plane face 70 and the bite edge 84 on the underside of the control chamber sleeve 31. Instead of the calked feature 58 shown in the drawing between the bell 60 and the piston 44, some other type of connection may be selected for joining the bell 60 to the piston 44. At position 58, a material-engagement connection in the form of a weld seam between the piston 44 and the bell 60 can be embodied; the material-engagement connection is produced after the introduction of the injection valve member that can be embodied as a nozzle needle and the subsequent mounting of the stop 62 between the piston 44 and the bell 60. Depending, on the dimensioning of the closing spring 52 received in the differential pressure chamber 54, the stroke length of the injection valve member 48 relative to the piston 44 can be defined.

Upon pressure relief of the control chamber 46, because of the dimensioning of the throttle restriction 56 upon opening, or in other words when the current supply to the piezoelectric actuator 14 is eliminated, a correspondingly delayed pressure buildup ensues in the differential pressure chamber 54 inside the piston 44, which communicates hydraulically with the control chamber 46 via the conduit containing the throttle restriction 56, and with this pressure buildup, an influence on the course over time of the fuel volume injected into the combustion chamber 88 via the injection openings 86 can be brought about.

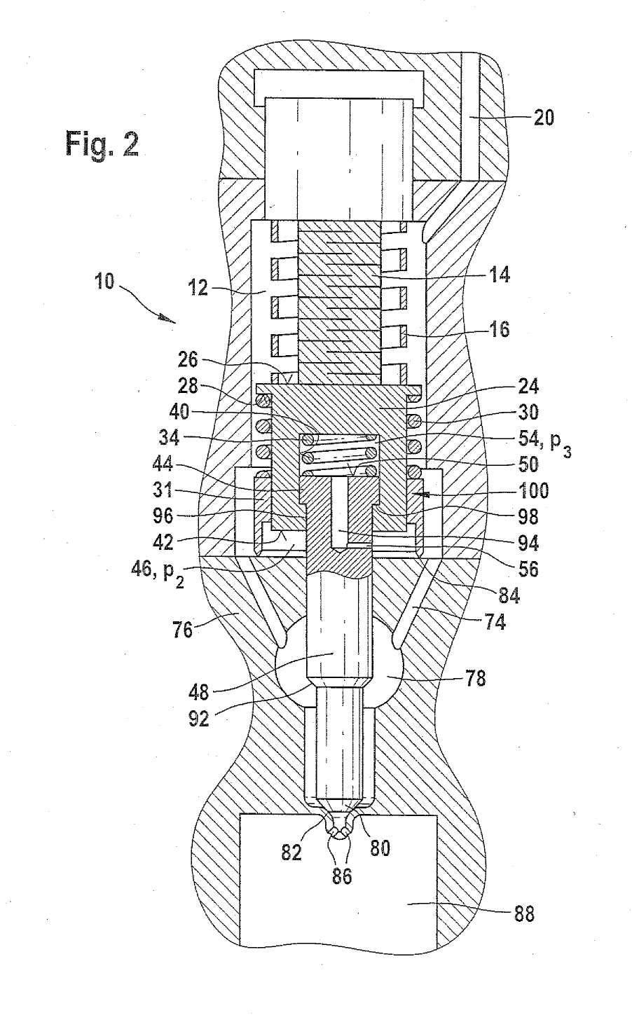

FIG. 2 shows a further variant embodiment of the fuel injector proposed according to the invention.

In the variant embodiment shown in FIG. 2, the booster piston 24 is acted upon directly—analogously to FIG. 1—by the inversely triggered actuator 14. The booster piston 24 is surrounded, analogously to what is shown in FIG. 1, by a spring element 30 embodied as a spiral spring, which positions the control chamber sleeve 31 against the nozzle body 76. The control piston 24 surrounds the differential pressure chamber 54 of the injection valve member 48, in which chamber an inner spring element 34 is disposed, and this element in turn acts on the face end 50 of the injection valve member 48. In this variant embodiment of the fuel injector proposed according to the invention, a pressure booster 100 includes only two hydraulic chambers, namely the differential pressure chamber 54 and the control chamber 46, while in the variant embodiment shown in FIG. 1, the pressure booster 100 includes the booster chamber 36, the control chamber 46, and the differential pressure chamber 54.

Analogously to what is shown in FIG. 1, in the variant embodiment shown in FIG. 2, the actuator 14 is received in a hollow chamber 12, which is acted upon through the supply line 20 to fuel that is at system pressure. From the hollow chamber 12, the fuel at system pressure flows through the injector body toward the conduits 74, which discharge into the nozzle chamber 78. In the nozzle chamber 78, there is a pressure stage 92, which is embodied on the injection valve member 48 that can be embodied in the form of a needle. In the variant embodiment shown in FIG. 2, the differential pressure chamber 54 and the control chamber 46 communicate with the throttle restriction 56 via a conduit 94. The injection valve member 48 in the variant embodiment in FIG. 2 includes a pistonlike extension 44, which is surrounded by an annular face 98 of the booster piston 24. In the view shown in FIG. 2, the pistonlike extension 44 of the injection valve member 48 rests on the annular face 98 of the booster piston 24.

From the nozzle chamber 78, an annular gap extends toward the seat 82 of the injection valve member 48. In the closing position, shown in FIG. 2, of the injection valve member that can be embodied as a nozzle needle, the injection openings 86 embodied below the seat 82 and discharging into the combustion chamber 88 are closed.

For opening the injection valve member 48, a partial or complete elimination of the current supply to the actuator 14 is effected. As a result, the booster piston 24 of the pressure booster 100 is pulled into the hollow chamber 12. The pressure in the control chamber 46 drops, and as a result the pressure in the differential pressure chamber 54 also drops, since these two hydraulic chambers 54, 46 are hydraulically in communication with one another via the throttle 56 and the conduit 94. Upon the retraction of the booster piston 24 into the hollow chamber 12, the annular face 98, which engages the pistonlike extension 44 of the injection valve member 48 from below, pulls the injection valve member 48 open. Since the pressure also drops in the differential pressure chamber 54 when the pressure in the control chamber 46 drops as a result of the outward motion of the booster piston 54, the pistonlike extension 44 of the injection valve member 48 lifts away from the annular face 98 and, guided in a piston guide 96 of the booster piston 24, moves with its face end 50 into the differential pressure chamber 54, as a result of which the injection valve member that can be embodied as a nozzle needle rapidly opens completely at only a minimal stroke of the actuator 14.

For closing the injection valve member 48, current is supplied to the actuator 14, causing its piezoelectric crystal stack to lengthen and subjecting the booster piston 24 to pressure. The face end 42 of the booster piston moves into the control chamber 46, in which the pressure rises as a consequence. Because of the hydraulic communication between the control chamber 46 and the differential pressure chamber 54 through the throttle restriction 56 with the conduit 94, the pressure also rises in the differential pressure chamber 54. The elevated pressure in the differential pressure chamber 54 acts on the face end 50 at the pistonlike extension 44 of the injection valve member 48 and moves it, counter to the hydraulic force in the nozzle chamber 78 engaging the pressure stage 92 embodied there, back into the seat 82, so that the injection openings 86 discharging into the combustion chamber 88 are again closed.

In comparison to the variant embodiment of the fuel injector shown in FIG. 1, the variant embodiment of the fuel injector shown in FIG. 2 includes a pressure booster 100 with two hydraulic chambers, namely the differential pressure chamber 54 and the control chamber 46, which are in hydraulic communication with one another via a conduit system with a throttle restriction 56.

While the mechanical coupling between the injection valve member 48 and the piston 44 is formed via a sleevelike stop 62 in the exemplary embodiment of FIG. 1, in the variant embodiment of FIG. 2 the booster piston 42, with an annular face 98, embraces the pistonlike extension 44 at the injection valve member 48. In both variant embodiments, the injection valve member that can be embodied as a nozzle needle is pulled open by means of the inversely triggered actuator 14 when the current supply to the actuator is partially or completely eliminated, and the further opening of the injection valve member 48 is performed in the variant embodiment of FIG. 1 by retraction into the differential pressure chamber 54 and in the variant embodiment of FIG. 2 by retraction of the face end 50 of the pistonlike extension 44 of the injection valve member 48 into the differential pressure chamber 54, which results in rapid opening of the injection valve member 48 that is preferably embodied as a nozzle needle.

### LIST OF REFERENCE NUMERALS

10 Fuel injector
12 Hollow chamber
14 Actuator (piezoelectric actuator)
16 Spring
20 Supply line
22 High-pressure source (common rail)
24 Booster piston
26 Face end
28 Annular face
30 Spring element
31 Control chamber sleeve
32 Extension
34 Inner spring element
36 Booster chamber (p₁)
38 High-pressure inlet
40 Inner circumferential surface of booster piston 24
42 Annular face of booster piston 24
44 Piston
46 Control chamber (P₂)
48 Injection valve member
50 Face end of injection valve member 48
52 Closing spring of injection valve member 48
54 Differential pressure chamber (p₃)
56 Conduit with throttle restriction
58 Connection site
60 Bell
62 Sleevelike stop
64 First side of sleevelike stop 62
66 Second side of sleevelike stop 62
68 Intermediate disk
70 First plane face
72 Second plane face
74 Extension of high-pressure inlet
76 Nozzle body
78 Nozzle chamber
80 Tip of injection valve member 48
82 Seat of injection valve member 48
84 Bite edge
86 Injection opening
88 Combustion chamber
90 Guide face of booster piston 24/piston 44
92 Pressure stage
94 Conduit
96 Piston guide
98 Annular face
100 Pressure booster

1-14. (canceled)

15. In a fuel injector with direct triggering of an injection valve member via an actuator that is received in a hollow chamber, which hollow chamber, via a high-pressure source disposed outside the fuel injector, is subjected to fuel that is at high pressure, the actuator is supplied with current in the closing position of the injection valve member and is not supplied with current in the open position of the injection valve member, and the actuator acts upon a booster piston of a pressure booster, the booster piston acting upon a booster chamber, the improvement comprising a control chamber sleeve received on the booster piston and defining a control chamber.

16. The fuel injector as defined by claim 15, wherein the booster piston of the pressure booster is acted upon directly by the actuator.

17. The fuel injector as defined by claim 15, further comprising a spring element associated with this booster piston and reinforcing the restoring motion of the booster piston.

18. The fuel injector as defined by claim 16, further comprising a spring element associated with this booster piston and reinforcing the restoring motion of the booster piston.

19. The fuel injector as defined by claim 15, wherein the booster piston simultaneously subjects the booster chamber and the control chamber to pressure or relieves them of pressure.

20. The fuel injector as defined by claim 16, wherein the booster piston simultaneously subjects the booster chamber and the control chamber to pressure or relieves them of pressure.

21. The fuel injector as defined by claim 17, wherein the booster piston simultaneously subjects the booster chamber and the control chamber to pressure or relieves them of pressure.

22. The fuel injector as defined by claim 19, wherein the control chamber communicates hydraulically with a differential pressure chamber of the injection valve member via a conduit containing a throttle restriction.

23. The fuel injector as defined by claim 15, wherein the booster chamber is defined by the booster piston and a piston, in which piston the injection valve member is movably guided.

24. The fuel injector as defined by claim 18, wherein the booster chamber is defined by the booster piston and a piston, in which piston the injection valve member is movably guided.

25. The fuel injector as defined by claim 15, further comprising a line containing a throttle restriction hydraulically coupling the differential pressure chamber and the control chamber to one another.

26. The fuel injector as defined by claim 19, further comprising a line containing a throttle restriction hydraulically coupling the differential pressure chamber and the control chamber to one another.

27. The fuel injector as defined by claim 25, wherein the control chamber is defined by the nozzle body, the control chamber sleeve, and an annular face of the booster piston.

28. The fuel injector as defined by claim 15, further comprising an annular face embodied on the booster piston and embracing the injection valve member.

29. The fuel injector as defined by claim 19 further comprising an annular face embodied on the booster piston and embracing the injection valve member.

30. The fuel injector as defined by claim 23, further comprising a stop disposed in the piston, the stop having first side on which the injection valve member rests and a second side engaged by the piston.

31. The fuel injector as defined by claim 30, wherein the stop is fixed by a bell that is received on the piston by material, positive, or nonpositive engagement.

32. The fuel injector as defined by claim 15, wherein the control chamber communicates hydraulically with a differential pressure chamber of the injection valve member via a conduit containing a throttle restriction, wherein the booster chamber is defined by the booster piston and a piston, in which piston the injection valve member is movably guided, and wherein in the closing state of the injection valve member and when current is supplied to the actuator, the booster piston subjects the piston to pressure directly via the booster chamber and subjects the differential pressure chamber of the injection valve member indirectly to pressure via the control chamber.

33. The fuel injector as defined by claim 15, wherein the control chamber communicates hydraulically with a differential pressure chamber of the injection valve member via a conduit containing a throttle restriction, wherein the booster chamber is defined by the booster piston and a piston, in which piston the injection valve member is movably guided, and wherein upon elimination of the current supply to the actuator, the booster chamber and the control chamber are pressure relieved, and a pressure relief of the differential pressure chamber of the injection valve member is effected in delayed fashion.

34. The fuel injector as defined by claim 33, wherein upon pressure relief of the differential pressure chamber, the injection valve member lifts from the stop.
